(19) United States
(12) Patent Application Publication
(10) Pub. No.: US 2004/0079801 A1
(43) Pub. Date: Apr. 29, 2004

(54) Method and device for changing operating mode for a chip card reader

(75) Inventor: Herve Cunin, Aixen Provence (FR)

Correspondence Address: Roland PLOTTEL, ROCKFELLER CENTER SM, PO Box 293, New York, NY, 10185-0293, US

(73) Assignee: Gemplue

(21) Appl. No.: 09/772,305

(22) Filed: Jan. 29, 2001

(30) Foreign Application Priority Data
Oct. 10, 2000 (FR) 00/13339

(51) Int. Cl. G06K 7/06

(52) U.S. Cl. 235/441

(57) ABSTRACT

Method and device for changing the operating mode of a chip card reader according to the standard of the card inserted into the reader. The sequence is (a) set the reader to one standard, (b) initialize the card, to obtain a response, (c) analyze the response to determine conformity with the standard, (d) if conformity, engage the card (e) if no conformity, deactivate the card and set the reader to another standard, (f) repeat (b)-(e) with the new standard. The device includes at least one two-position switching-circuit connectable to a modules of different standards, a circuit for detecting the presence of a card in the reader, and at least one logic-unit for determining the position of the switching-circuit according to the presence or absence of the card in the reader and the response of the card as to conformity with the standard engaged.

The invention relates to the field of microcircuit cards, better known by the term “chip cards”, and more particularly a method and device for effecting the change of operating mode of the chip card reader so as to adapt it to the type of card inserted into the reader.

Each type of chip card can function according to different standards as defined by standards or bodies and the chip card reader must be capable of recognising the type of card and adapting to its operating mode.

More particularly, the chip card reader must be capable of functioning according to the different standards and a change from one standard to another whilst complying to the constraints of each one.

This problem arises notably for applications implementing the standards known as “PCSC”, which is the acronym of the English expression “Personal Computer Smart Card”, and “EMV”, which is the acronym of the English expression “Europay Mastercard and Visa”.

It should be noted that the EMV standard is used in banking transactions whilst the PCSC standard is used in relation to personal computers.

One solution to this problem is to use two chip card readers, one per type of chip card, the choice of reader being made by the carrier of the chip card, which assumes that he knows the type of card and that it is indicated to him which reader to use. Such a solution may lead to detrimental manipulations.

A better solution consists in having a single reader capable of managing the two standards, which can be selected by means of an intervention external to the reader, either by the card user, or by software. In such a solution, there may be many errors resulting in mismatches between the card and the standard applying to the reader.

One aim of the, present invention is therefore to use a method and to produce a device which enables the chip card reader to be set to the standard corresponding to that of the chip card inserted.

To this end, the invention provides a means in the chip card reader to enable it to know the standard according to which the chip card is able to function.

The invention relates to a method of changing the operating mode in a chip card reader capable of functioning according to N≧2 standards relating to the use of a chip card in order to adapt it to the standard of the chip card inserted into the reader, characterised in that it comprises the following operations consisting in;

(a) positioning the chip card reader according to one standard amongst N,

(b) initialising the chip card in order to obtain an ATR response, ATR being the acronym of the English expression “Answer to Reset”,

(c) analysing the ATR response according to the standard engaged in order to determine its conformity with it,

(d) in the case of conformity, managing the chip card according to the standard engaged,

(e) in the case of absence of conformity, deactivating the chip card and setting the reader to another standard,

(f) repeating operations (b), (c), (d) and (e) with the new standard engaged.

Operation (e) is performed only as long as the chip card is not removed from the reader.

During operation (e), the reader can be positioned in a state integrating several standards.

Operation (f) is repeated at a maximum (N−1) until an appropriate standard amongst N intervenes.

Operation (e) comprises a complementary operation consisting in indicating to the user and/or the application the standards not yet engaged.

The standards not yet engaged which are indicated do not include those which are liable not to correspond to the chip card inserted into the reader.

The invention also relates to a device for implementing the methods described above, characterised in that it comprises

at least one two-position switching circuit which makes it possible to connect a communication channel either to a module of one standard, or to a module of another standard,

a circuit for detecting the presence or absence of a chip card in the reader, and

at least one logic unit for determining the position of the switching circuit according to the presence or absence of the chip card in the reader and the ATR response of the chip card conforming or not to the standard engaged.

When the reader can function to N standards, the device according to the invention comprises N modules of standards, (N−1) switching circuits and (N−1) logic unite.

Other characteristics and advantages of the present invention will emerge from a reading of the following description of particular example embodiments, the said description being given in relation to the accompanying drawings, in which:

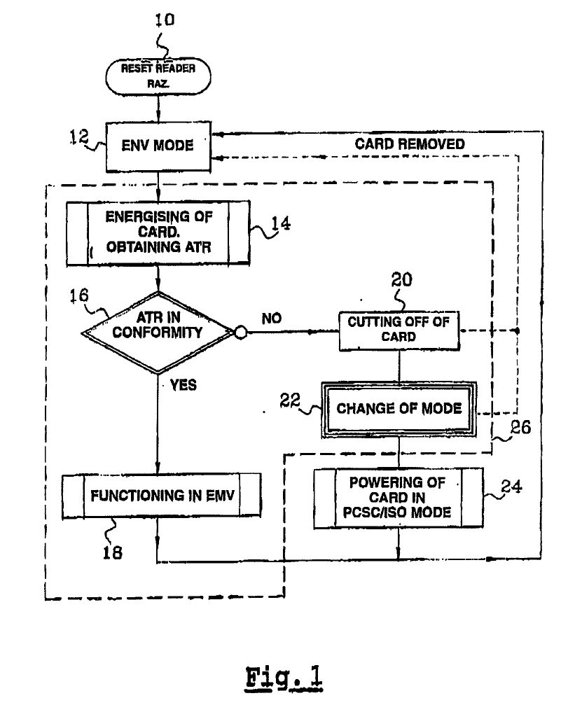

FIG. 1 is a flow diagram illustrating the different operations of the method according to the invention,

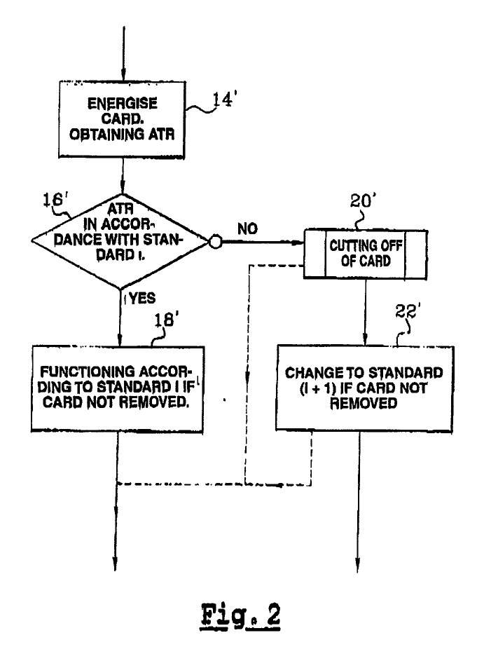

FIG. 2 is a flow diagram illustrating the different operations of the method according to the invention in the case where the reader can function to several standards,

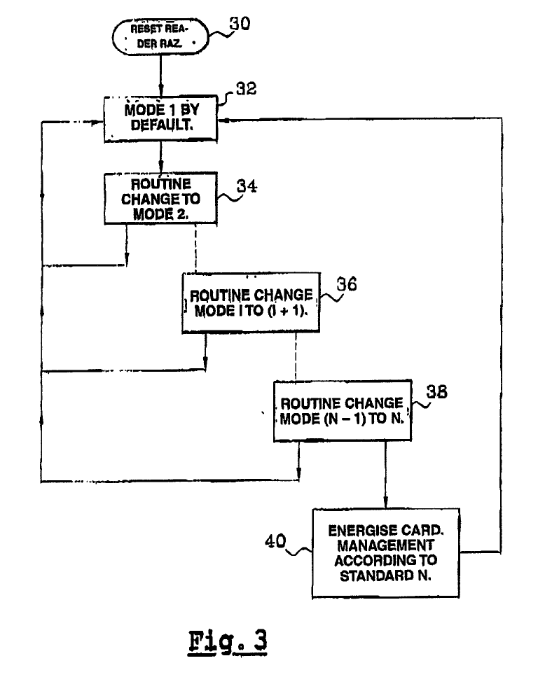

FIG. 3 is a flow diagram illustrating the functioning of the flow diagram of FIG. 2,

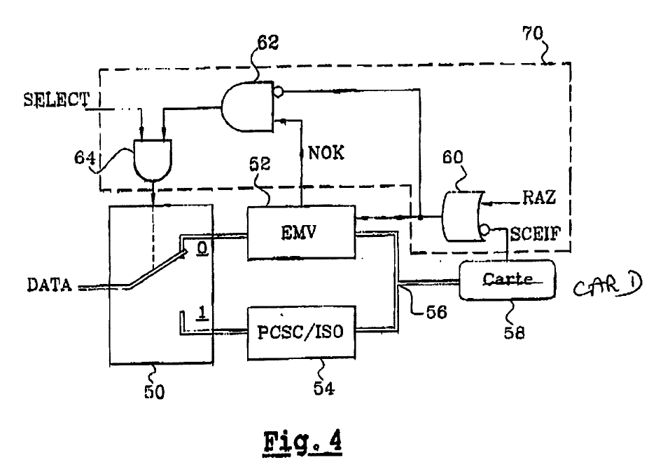

FIG. 4 is a functional diagram of a device according to the invention,

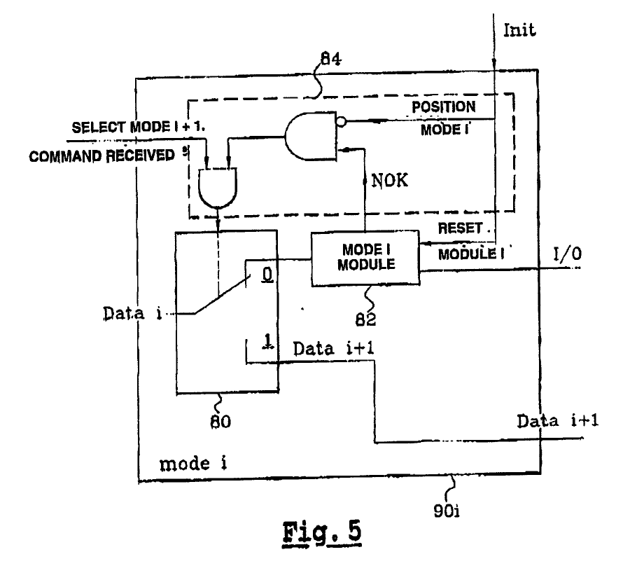

FIG. 5 is a diagram of a circuit for selecting between two standards, and

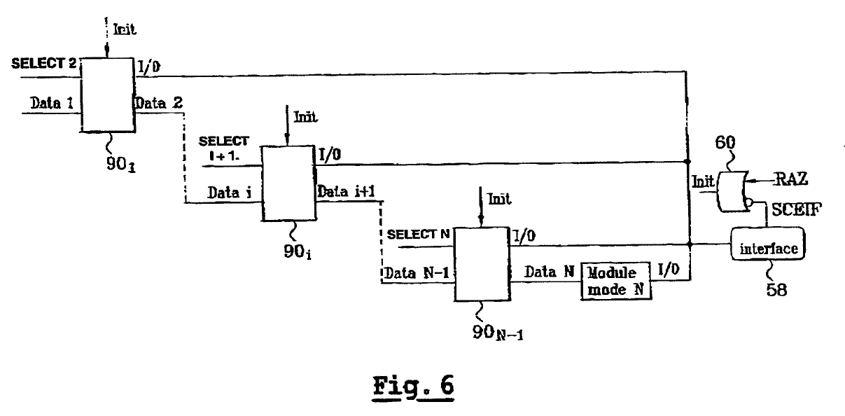

FIG. 6 is a diagram of a selection of circuits for N≧2.

The invention will be described in its application to the selection between two chip cards standards, those mentioned above under the acronyms “ENV” and “PSV” as well as the ISO standard defined by ISO 7816-3, including memory cards.

The first operation 10 consists of an initialisation A of the chip card reader, this initialisation leading to an initial state in which the reader is positioned by default according to the EMV standard (state 12).

After insertion of the chip card, the latter is energised by the reader either under the effect of an external command or automatically (operation 14).

In accordance with the standards, the reader is in a position to be able to receive a response ATR corresponding to the English expression “Answer to Reset” when the card is reset to 0 (RAZ) after it is energised.

This response ATR is then analysed (operation 16) by the reader. Where the response ATR corresponds to the EMV standards, then the card is processed according to this standard until it is de-activated by the reader or removed from the latter (operation 18). The reader returns to state 12. Where the response ATR is not in accordance with the EMV standard, the card is de-activated by he reader (operation 20).

As long as the chip card is not removed from the reader, the latter can propose, according to the application, to make a choice between or to other standards and, notably, to propose changing to the PCSC and/or ISO standard and/or to be able to manage the memory card as long as the card is not removed (operation 22).

The choice is left to the user or to the application.

If the choice puts the reader in a state integrating several standards, and able to be selected without constraint, a mode is then spoken of. In the remainder of he description, the term “standard” then relates to a single standard or a set of standards referred to as the “mode”.

Once this choice has been made, the card is then energized again so as to be able to function according to the standard or mode selected (operation 24).

The method returns to state 12 when the chip card is removed or de-activated.

Instead of proposing the choice defined above, the reader can position itself automatically in the PCSC and/or ISO standards; the reader would make it known which standard is engaged.

Where the reader can function to a number N of standards greater then 2, provision can be made for a repetition of the operations 14, 16, 18, 20 and 22 to allow a choice between the different standards, the number of repetitions being no more than (N−1). The operations referred to are those of the rectangle in a broken line 26 and have been explained in the flow diagram in FIG. 2, the operations being referenced 14′, 16′ 18′, 20′ and 22′.

These operations are identical to those of the flow diagram in FIG. 1 but the ATR expected is the one relating to the standard of rank i amongst N with N≧2. This flow diagram is used in the manner which will be described in relation to FIG. 3.

When the reader is initialised (operation 30), it is positioned in the default mode (operation 32) which is the standard. The first routine 34 allows a change from standard N^{o} 1 to standard N^{o} 2 where the default standard (N^{o} 1) is not suitable.

In general terms, a routine 36 makes it possible to change from a standard “i” to a standard “i+1” and so on until the standard of rank N−1.

Then a last routine 38 makes it possible to change from the standard N−1 to the standard N.

At the end of this last routine, the chip card is energised (operation 40) so as to function under the standard N^{o} N.

The method described in relation to FIGS. 1, 2 and 3 can be implemented by means of software or a device according to the functional diagram of FIG. 4.

In this diagram, the following legends have the following meanings:

DATA designates the input of a communication channel for the data input or output between the card and the reader.

EMV is the module of the reader which enables it to function according to the EMV standards,

PCSC/ISO is the module of the reader which enables it to function according to the PCSC and/or ISO standard, and/or memory card.

SCEIF is a circuit which supplies a signal indicating the presence (“1” state) or absence (“0 states”) of the chip card,

SELECT is a signal indicating that the selection of the standard has been received.

RAZ is the signal which initialises the reader,

NOK is a signal which indicates that the ATR is not in conformity.

The input DATA of the communication channel is connected to one of the modules EMV or PCSC/ISO by means of a switch 50 according to the position of the switch, This position of the switch is determined by a logic unit 70.

This logic unit 70 comprises a logic OR circuit 60 and two AND circuits 62 and 64.

The OR circuit 60 has a first input terminal to which there is applied the initialisation signal RAZ of the reader and a second input terminal to which there is applied the output signal of the circuit SCEIF but inverted. The output terminal of the OR circuit 60 is connected on the one hand to the module EMV and on the other hand to the first input terminal of the EMV circuit 62 in the inverted form. The second input terminal is connected to the module EMV and receives the non-conformity signal NOK of the response ATR according to the standard EMV. The output terminal of the EMV circuit 62 is connected to a first input terminal of the EMV circuit 64, whose other input terminal receives the signal SELECT.

The functioning of the device is as follows. When there in no card inserted in the reader, the signal SCEIF is at the “0” state, which gives a “1” state at the input of the OR circuit 60. The result is a “1” state at its output terminal, a “1” state which resets the module EMV to 0, which entails a “0” state of the signal NOK output from the module EMV. A signal of this “1” state is inverted at the input terminal of the EMV circuit 62. The output terminal is then at the “0” state, a “0” state which, applied to the EMV circuit 64, maintains the switch 50 in the state indicated by default.

In the case of the presence of the signal RAZ, the states obtained are the same as before, whence the maintenance of the switch in the default state. When the card is inserted, a “0” state signal is applied at the input of the OR circuit 60, or a “0” state at the output terminal if the signal RAZ is at the “0” state. There is no resetting to 0 of the module EMV and the input of the EMV circuit 62 is at the “1” state. The output 62 is at the “0” state as long as the signal NOK is at the “0” state. This “0” state maintains the switch in the default state even if the signal SELECT in at the “1” state.

In the case of a signal RAZ at the “1” state, the EMV module is reset to 0 and the switch is set to the “0” state by default.

In the case of the insertion of a card and in the absence of the RAZ signal, the output of the OR circuit 60 is at the “0” state, so that the module EMV is not reset to 0 and the input of the AND circuit 62 is at the “1” state. If NOK is at the “1” state, the output of the AND circuit 62 is at the “1” state so that, if the signal SELECT goes to the “1” state, the output of the AND circuit 64 goes to the “1” state and changes the position of the switch to the position where the data are directed to the PCSC/ISO module. This makes it possible to manage the card in the PCSC/ISO mode as well as the memory cards.

A mode is therefore characterised by the state integrating one or more standards without any particular constraint.

Where there are more than two standards or modes, the device according to the invention can be implemented according to the diagrams in FIGS. 5 and 6.

The diagram in FIG. 5 corresponds partly to the one in FIG. 4 and makes the selection between two standards, between that of rank i and that of rank i+1.

It comprises;

a switching circuit 80,

a module 82 for managing the standard or mode of rank i,

a logic unit 84.

This diagram does not include the circuit for detecting the presence or absence of the chip card in the reader, this circuit being common to the whole of the device.

This common circuit comprises the elements 58 and 60 described above with FIG. 4 and supplies a signal “INIT” which, as indicated below, is applied to each selection circuit 9O₁. . ., 90₁. . ., 90_{N-1}.

The different selection circuits 90_{1.} to 90_{N-1} are connected in cascade according to the diagram in FIG. 6. Through this connection in cascade, the data of the communication channel can be switched to one of the standard modules according to the position of the switching circuit 80. Thus the communication channel is connected to the module of rank 1 when the first switch is at the “0” state. It is connected to the module of rank 2 when the second switch is at the “0” state and so on.

The above description shows that the method of changing functioning in a chip card reader capable of functioning according to N≧2 standards relating to the use of a chip card for adapting it to the standard of the chip card inserted into the reader comprises the following operations consisting in:

(a) positioning the chip card reader according to one standard amongst N,

(b) initialising the chip card in order to obtain an ATR response,

(c) analysing the ATR response according the standard engaged in order to determine its conformity with it,

(d) in the case of conformity, managing the chip card according to the standard engaged,

(e) in the case of absence of conformity, deactivating the chip card and setting the reader to another standard,

(f) repeating operations (b), (c), (d) and (e) with the new standard engaged.

Operation (e) is performed only as long as the chip card is not removed from the reader.

Operation (f) is repeated a maximum of N−1 times until the appropriate standard is obtained.

Operation (e) can comprise a complementary operation consisting in indicating the standards not yet engaged to the user and/or to the software used. This indication may not include the standards which are not able to correspond to the chip card inserted in the reader.

1. A method of changing operating mode in a chip cord reader capable of functioning according to N≧2 standards relating to the use of a chip card for adapting it to the standard of the chip card inserted in the reader, characterised in that it comprises the following operations consisting in:
(a) positioning the chip card reader according to one standard amongst N,
(b) initialising the chip card in order to obtain a response (ATR),
(c) analysing the response (ATR) according to the standard engaged in order to determine its conformity is with it,
(d) in the case of conformity, managing the chip card according to the standard engaged,
(e) in the case of absence of conformity, deactivating the chip card and setting the reader to another standard,
(f) repeating operations (b), (c), (d) and (e) with the new standard engaged.

2. A method according to claim 1, characterised in that operation (e) is performed only as long as the chip card is not removed from the reader.

3. A method according to claim 1 or 2, characterised in that operation (e) is defined as follows:
in the case of absence of conformity, de-activating the chip card and positioning the reader in a state integrating several standards.

4. A method according to one of claims 1 to 3 characterised in that operation (f) is repeated a maximum (N−1) times until the intervention of an appropriate standard amongst N standards.

5. A method according to one of claims 1 to 4, characterised in that operation (e) comprises a complementary operation consisting in indicating the standards not yet engaged.

6. A method according to claim 5, characterised in that the standards not yet engaged are indicated to the user and/or to the application.

7. A method according to claim 5 or 6, characterised in that the standards not yet engaged which are indicated do not include those which are liable not to correspond to the chip card inserted into the reader.

8. A device for implementing the method according to one of claims 1 to 7, in a chip card reader, characterised in that it comprises:
at least one two-position switching circuit which makes it possible to connect a communication channel either to a module of one standard, or to a module of another standard,
a circuit for detecting the presence or absence of a chip card in the reader, and
at least one logic unit (70) for determining the position of the switching circuit according to the presence or absence of the chip card in the reader and the response (ATR) of the chip card conforming or not to the standard engaged.

9. A device according to claim 8 in its application to the use of N standards by the chip card reader, characterised in that there are N modules of standards, (N−1) switching circuits and (N−1) logic units.
